(19) United States
(12) Patent Application Publication
(10) Pub. No.: US 2023/0041863 A1
(43) Pub. Date: Feb. 9, 2023

(54) NUMERICAL CONTROL DEVICE AND METHOD FOR CONTROLLING ADDITIVE MANUFACTURING APPARATUS

(71) Applicant: Mitsubishi Electric Corporation, Tokyo (JP)

(72) Inventors: Seiji UOZUMI, Tokyo (JP); Nobuhiro SHINOHARA, Tokyo (JP); Nobuyuki SUMI, Tokyo (JP)

(73) Assignee: Mitsubishi Electric Corporation, Tokyo (JP)

(21) Appl. No.: 17/793,040

(22) PCT Filed: Mar. 6, 2020
(86) PCT No.: PCT/JP2020/009844

§ 371 Date: Jul. 15, 2022

(51) Int. Cl. G05B 19/418; B29C 64/118; B29C 64/268; B29C 64/393

(52) U.S. Cl. CPC G05B 19/41835; B29C 64/118; B29C 64/268; B29C 64/393; G05B 2219/49023; G05B 2219/45138; B33Y 50/02

(57) ABSTRACT

An NC device as a numerical control device controls an additive manufacturing apparatus for producing an object by layering, on a workpiece, a material melted by being irradiated with a beam. The NC device includes: a feature quantity extracting unit that extracts, from image data, a feature quantity for determining a welding state that is a state where a molten material is added to the workpiece; and a process map creating unit that creates a process map in which a shape of the object and a layering condition are associated with each other. The layering condition is selected from among a plurality of layering conditions on the basis of a result of determination of the welding state, and includes at least one of beam intensity and a supply amount of a material.

### FIELD

The present disclosure relates to a numerical control device that controls an additive manufacturing apparatus, and a method for controlling an additive manufacturing apparatus.

### BACKGROUND

Additive manufacturing apparatuses for manufacturing objects having solid shapes by the direct energy deposition (DED) technology are known. Some additive manufacturing apparatuses locally melt a material by a beam emitted from a machining head, and add the molten material to a workpiece. Additive manufacturing apparatuses have a feature that achieves building with high degrees of freedom. A shape that is difficult to form by cutting can be easily formed by additive manufacturing apparatuses.

In a case where an additive manufacturing apparatus is controlled by a numerical control device, machining programs to be input to the numerical control device are typically created by a computer aided manufacturing (CAM) device. The numerical control device analyzes a machining program to thereby obtain a movement path along which to move a machining head, and generate a position command, which is a group of interpolation points each defined per unit time on the movement path. The numerical control device controls an operation mechanism of the additive manufacturing apparatus in accordance with the position command. The numerical control device also generates commands matching a machining condition specified by the machining program. The numerical control device controls a beam source by generating commands in accordance with conditions on beam intensity. The numerical control device controls a supply source of the material such as metal powder or a metal filament by generating commands in accordance with conditions on the supply amount of the material.

Irradiation of a material and a workpiece with beams melts part of the workpiece, and a molten pool having a molten material accumulated therein is formed on the workpiece. The molten material supplied into the molten pool then solidifies, and a layer made of the solidified molten material is formed on the workpiece. The numerical control device performs adjustment for obtaining a target object on various command values such as a moving speed of the machining head relative to the workpiece, a material supply amount, a beam intensity, and a gas supply amount.

The technique for assisting in determining conditions for building is disclosed in Patent Literature 1. Specifically, Patent Literature 1 discloses an additive manufacturing apparatus that models a cross section of each layer of an object with an ellipse and creates a database that represents parameters representing elliptical models and building conditions.

### CITATION LIST

### Patent Literature

Patent Literature 1: Japanese Patent Application Laid-open No. 2018-27558

### SUMMARY

### Technical Problem

A numerical control device can support highly accurate building in a stable welding state as the numerical control device stores a databased process map in which a welding state which is a state where a molten material is added to a workpiece, a shape of a layer to be formed, and a layering condition which is a condition for forming the layer are associated with each other. For the conventional technique disclosed in Patent Literature 1 to create the process map, the additive manufacturing apparatus performs building under each of a plurality of layering conditions, and an operator checks a welding state. It takes time and effort to create the process map in such a manner. The conventional technique suffers from the problem of being difficult for the numerical control device to improve work efficiency in adjustment for obtaining a target object.

The present disclosure has been made in view of the above, and an object thereof is to obtain a numerical control device capable of improving work efficiency in adjustment for obtaining a target object.

### Solution to Problem

In order to solve the above-described problem and achieve the object, a numerical control device according to the present disclosure controls an additive manufacturing apparatus for producing an object by layering a material on a workpiece, the material being melted by being irradiated with a beam. The numerical control device according to the present disclosure comprises: a feature quantity extracting unit to extract, from image data, a feature quantity for determining a welding state that is a state where a molten material is added to the workpiece; and a process map creating unit to create a process map in which a shape of the object and a layering condition are associated with each other, the layering condition being selected from among a plurality of layering conditions on a basis of a result of determination of the welding state and including at least one of beam intensity and a supply amount of a material.

### Advantageous Effects of Invention

A numerical control device according to the present disclosure produces an advantageous effect of improving work efficiency in adjustment for obtaining a target object.

### BRIEF DESCRIPTION OF DRAWINGS

FIG. 1 is a diagram illustrating an additive manufacturing apparatus controlled by a numerical control device according to a first embodiment.

FIG. 2 is a diagram illustrating a functional configuration of the numerical control device according to the first embodiment.

FIG. 3 is a diagram for explaining a welding state at a time of building by the additive manufacturing apparatus illustrated in FIG. 1.

FIG. 4 is a flowchart illustrating procedures of operation performed by the numerical control device according to the first embodiment.

FIG. 5 is a diagram illustrating an example of a process map created by the numerical control device according to the first embodiment.

FIG. 6 is a diagram illustrating an example of a movement path used in creation of a process map by the numerical control device according to the first embodiment.

FIG. 7 is a graph illustrating an example of a speed waveform determined by the numerical control device according to the first embodiment.

FIG. 8 is a diagram for explaining feature quantity data obtained by the numerical control device according to the first embodiment.

FIG. 9 is a graph for explaining a relational expression used for estimation of a molten state performed by the numerical control device according to the first embodiment.

FIG. 10 is a graph illustrating an example of a result of estimation of a molten state for each layering condition performed by the numerical control device according to the first embodiment.

FIG. 11 is a diagram illustrating a functional configuration of a numerical control device according to a second embodiment.

FIG. 12 is a flowchart illustrating procedures of operation performed by the numerical control device according to the second embodiment.

FIG. 13 is a graph for explaining a change in the content of a layering condition performed by the numerical control device according to the second embodiment.

FIG. 14 is a diagram illustrating a functional configuration of a numerical control device according to a third embodiment.

FIG. 15 is a block diagram illustrating a functional configuration of a machine learning device of the numerical control device according to the third embodiment.

FIG. 16 is a diagram illustrating an example configuration of a neural network used for learning in the third embodiment.

FIG. 17 is a first diagram illustrating an example of a hardware configuration of the numerical control devices according to the first to third embodiments.

FIG. 18 is a second diagram illustrating an example of a hardware configuration of the numerical control devices according to the first to third embodiments.

### DESCRIPTION OF EMBODIMENTS

A numerical control device and a method for controlling an additive manufacturing apparatus according to each embodiment will be hereinafter described in detail with reference to the drawings. In the following description, the numerical control device may be referred to as a numerical control (NC) device.

### First Embodiment

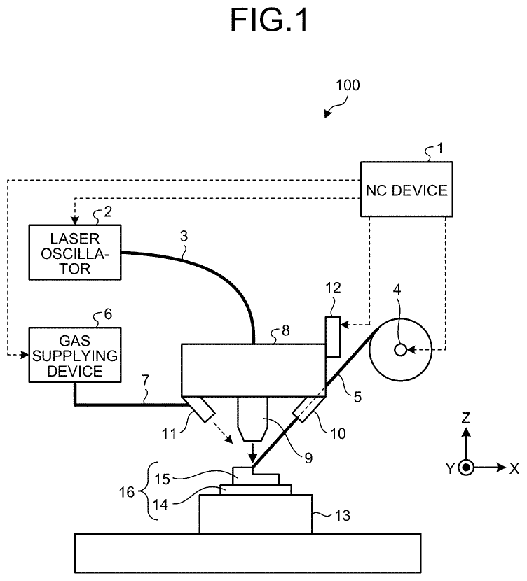

FIG. 1 is a diagram illustrating an additive manufacturing apparatus controlled by a numerical control device according to a first embodiment. The additive manufacturing apparatus 100 is a machine tool for manufacturing an object 15 by adding a molten material 5 to a workpiece 16. In the first embodiment, a beam is a laser beam, and the material 5 is a metal filament. The material 5 used in the additive manufacturing apparatus 100 is not limited to a metal filament, and may be metal powder.

The additive manufacturing apparatus 100 forms an object 15 on the surface of a base material 14 by stacking layers formed by solidification of the molten material 5. The base material 14 is placed on a stage 13. In the following description, the workpiece 16, which has the molten material 5 added thereto, refers to the base material 14 and the object 15. The base material 14 illustrated in FIG. 1 is a plate. The base material 14 may be a material other than a plate.

The additive manufacturing apparatus 100 includes a machining head 8 that moves relative to the workpiece 16. The machining head 8 includes a beam nozzle 9, a material nozzle 10, and a gas nozzle 11. The beam nozzle 9 emits a laser beam toward the workpiece 16. The material nozzle 10 advances the material 5 toward a laser-beam irradiation position on the workpiece 16. The gas nozzle 11 emits a jet of gas toward the workpiece 16. With gas jets, the additive manufacturing apparatus 100 inhibits oxidation of the modeled object 15 and cools the layers formed on the workpiece 16.

A laser oscillator 2, which is a beam source, emits an oscillating laser beam. The laser beam from the laser oscillator 2 is propagated to the beam nozzle 9 via a fiber cable 3, which is an optical transmission path. A gas supplying device 6 supplies gas to the gas nozzle 11 via piping 7.

A material supplying device 4 is a supply source of the material 5. The material supplying device 4 includes a driving unit for feeding the material 5, which is a metal filament. The material 5 fed from the material supplying device 4 passes through the material nozzle 10 and is supplied to the irradiation position of the laser beam.

A head drive unit 12 includes servomotors defining an operation mechanism for moving the machining head 8. The head drive unit 12 moves the machining head 8 in each of an X-axis direction, a Y-axis direction, and a Z-axis direction. The X axis, the Y axis, and the Z axis are three axes perpendicular to one another. The X axis and the Y axis are parallel to the horizontal direction. The Z-axis direction is the vertical direction. In FIG. 1, the servomotors are not illustrated. In the additive manufacturing apparatus 100, the head drive unit 12 moves the machining head 8 to move the laser-beam irradiation position on the workpiece.

The machining head 8 illustrated in FIG. 1 emits the laser beam in the Z-axis direction from the beam nozzle 9. The material nozzle 10 is located at a position away from the beam nozzle 9 in the XY plane, and advances the material 5 in a direction at an angle to the Z axis. The machining head 8 is not limited to that which advances the material 5 in a direction at an angle to the Z axis, and may advance the material 5 along the central axis of the laser beam emitted from the beam nozzle 9. Thus, the beam nozzle 9 and the material nozzle 10 may be arranged coaxially with each other. In this case, the beam nozzle 9 emits a laser beam having its cross sectional shape adjusted to a ring shape around the material 5, or emits a plurality of laser beams distributed around the material 5. Such laser beams are adjusted so as to converge at the irradiation position on the workpiece 16.

The gas nozzle 11 is located at a position away from the beam nozzle 9 in the XY plane, and emits a jet of gas in a direction at an angle to the Z axis. The gas nozzle 11 is not limited to that which emits a jet of gas in a direction at an angle to the Z axis, and may emit a jet of gas along the central axis of the laser beam emitted from the beam nozzle 9. Thus, the beam nozzle 9 and the gas nozzle 11 may be arranged coaxially.

The additive manufacturing apparatus 100 moves the laser-beam irradiation position on the workpiece 16 by moving the machining head 8 relative to the workpiece 16. Alternatively, the additive manufacturing apparatus 100 may move the laser-beam irradiation position on the workpiece 16 by moving the workpiece 16 relative to the machining head 8. Note that, in the description below, the laser-beam irradiation position may simply be referred to as the “irradiation position”.

An NC device 1 controls the additive manufacturing apparatus 100 in accordance with a machining program. The NC device 1 outputs a position command to the head drive unit 12 to control the position of the head drive unit 12. The NC device 1 outputs an output command to the laser oscillator 2 to control the laser oscillation of the laser oscillator 2. The output command is a command corresponding to the condition of beam intensity.

The NC device 1 outputs a supply command to the material supplying device 4 to control the material supplying device 4. The supply command is a command corresponding to the condition of the amount of supply of the material 5. When the material 5 is a metal filament, the supply command output from the NC device 1 may be a command corresponding to the condition of the supply rate of the material 5. The supply rate is the speed of the material 5 moving from the material supplying device 4 toward the irradiation position. The supply rate refers to the amount of supply of the material 5 per hour.

The NC device 1 outputs a command corresponding to the condition of the gas supply amount to the gas supplying device 6 to thereby control the amount of gas supply from the gas supplying device 6 to the gas nozzle 11. Note that the NC device 1 may be one of the components of the additive manufacturing apparatus 100 or a device external to the additive manufacturing apparatus 100.

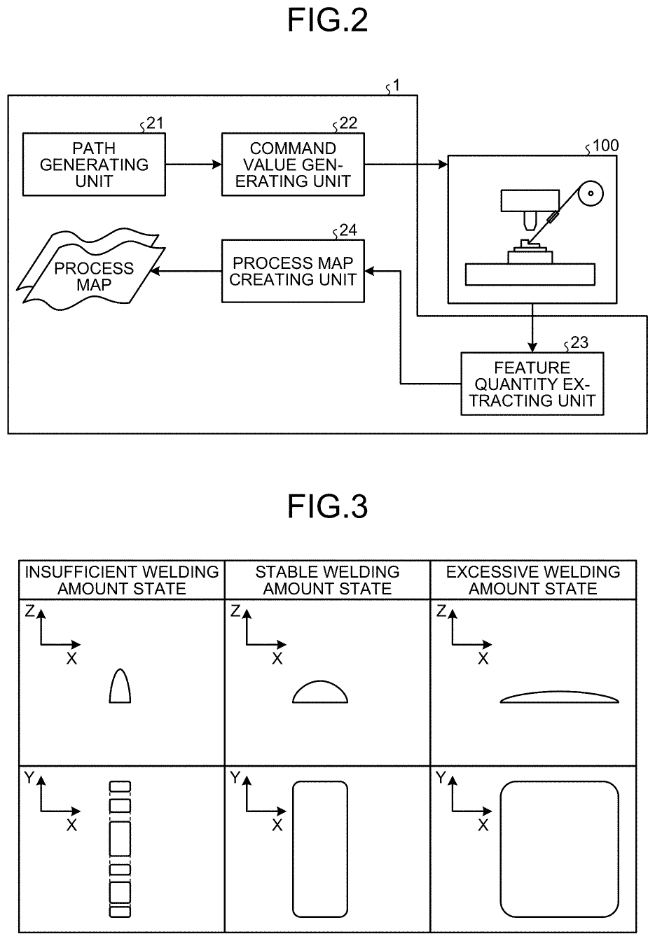

FIG. 2 is a diagram illustrating a functional configuration of the numerical control device according to the first embodiment. The NC device 1 includes a path generating unit 21, a command value generating unit 22, a feature quantity extracting unit 23, and a process map creating unit 24. The path generating unit 21 generates a movement path. The command value generating unit 22 generates various command values. The feature quantity extracting unit 23 extracts, from image data, a feature quantity for determining a welding state. The process map creating unit 24 creates a process map.

The path generating unit 21 obtains a movement path in accordance with conditions set for creating a process map. The movement path is a path along which to move a supply position of the material 5. The path generating unit 21 outputs data indicating the movement path to the command value generating unit 22. In addition, the path generating unit 21 determines beam intensity, the supply amount of the material 5, and the moving speed of the supply position on the movement path in accordance with the conditions set for creating the process map.

In accordance with the data indicating the movement path and the determined moving speed, the command value generating unit 22 generates a position command which is a group of interpolation points each defined per unit time on the movement path. The command value generating unit 22 outputs the position command to the head drive unit 12. The head drive unit 12 drives the machining head 8 in accordance with the position command.

The command value generating unit 22 generates an output command in accordance with the determination by the path generating unit 21. The output command is a command value for the beam intensity. The command value generating unit 22 outputs the generated output command to the laser oscillator 2. The laser oscillator 2 emits an oscillating laser beam in accordance with the output command. The command value generating unit 22 generates a supply command in accordance with the determination by the path generating unit 21. The supply command is a command value for the supply amount. The command value generating unit 22 outputs the generated supply command to the material supplying device 4. The material supplying device 4 supplies the material 5 in accordance with the supply command. The NC device 1 outputs various commands to control the entire additive manufacturing apparatus 100.

A device for obtaining an image of an object during building is installed in the additive manufacturing apparatus 100. An example of such a device is a camera that images the object. Image data indicating the object during building is input to the NC device 1. The feature quantity extracting unit 23 obtains feature quantity data by extracting a feature quantity from the image data. The feature quantity is a parameter for determining a welding state from states of the material 5 and a molten pool formed of the material 5 melted on the workpiece 16. The welding state is a state where a molten material is added to the workpiece 16. The image data may be either still image data or video data.

In addition, the feature quantity extracting unit 23 obtains, from the image data, shape data indicating the shape of a layer. The shape data includes data on layering height and data on layering width. The layering height is the height of a layer in the height direction in which layers are stacked together. The laying height is the height of a layer formed by a single building. The layering width is the width of a layer in the width direction perpendicular to the length direction and the height direction. The layering width is the width of a layer formed by a single building. A layering shape is a three-dimensional shape of a layer formed by a single building. A layer formed by a single building may be hereinafter referred to as a bead. The feature quantity extracting unit 23 outputs the feature quantity data and the shape data to the process map creating unit 24.

The process map creating unit 24 determines the welding state on the basis of the feature data. The process map creating unit 24 creates a process map in which the shape of an object and a layering condition are associated with each other, the layering condition being selected from among a plurality of layering conditions on the basis of the result of determination of the welding state and including at least one of the beam intensity and the supply amount of the material.

FIG. 3 is a diagram for explaining a welding state at a time of building by the additive manufacturing apparatus illustrated in FIG. 1. FIG. 3 illustrates an example of the shape of a bead for each of the three welding states. FIG. 3 illustrates the shape of each bead when the bead is viewed from a Y direction and the shape of each bead when the bead is viewed from a Z direction.

An “insufficient welding amount state”, which is a first welding state, is a state where a target shape is not formed, due to insufficient addition of a molten material to the workpiece 16. The layer formed in the “insufficient welding amount state” lacks a part of the target shape. A “stable welding amount state”, which is a second welding state, is a state where a layer having the target shape is formed. An “excessive welding amount state”, which is a third welding state, is a state where the target shape is not formed, due to excessive addition of the molten material to the workpiece 16. The layering width of a layer formed in the “excessive welding amount state” is larger than the layering width of the target shape, and the layering height of the layer formed in the “excessive welding amount state” is smaller than the layering height of the target shape. The process map creating unit 24 registers, in the process map, a command value of laser output, a command value of supply amount, and the shape data when building is performed in the “stable welding amount state”.

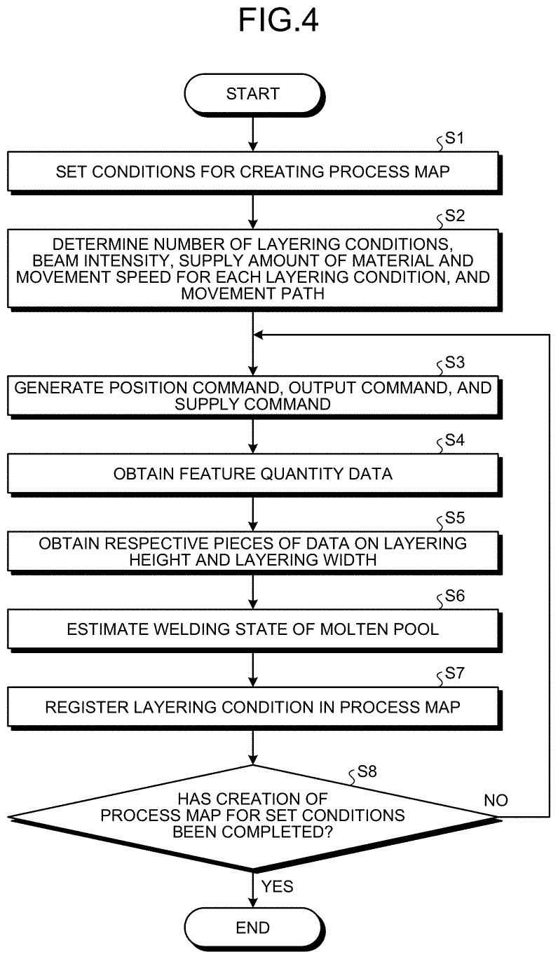

Next, the operation of the NC device 1 will be explained. FIG. 4 is a flowchart illustrating procedures of operation performed by the numerical control device according to the first embodiment.

(Step S1)

In step S1, the NC device 1 sets conditions for creating a process map. The set conditions are information such as the size of the workpiece 16, a material of the workpiece 16, the diameter of a metal filament which is the material 5, the range of the beam intensity, and the range of the supply amount of the material 5. Such information is input to the path generating unit 21. The beam intensity can vary with a change to a layering condition. The range of the beam intensity is a range in which the beam intensity can vary with a change to a layering condition among a plurality of layering conditions. The supply amount can vary with a change to a layering condition. The range of the supply amount is a range in which the supply amount can vary with a change to a layering condition among a plurality of layering conditions. Note that the above information may be information such as parameters stored in advance in the NC device 1. After performing step S1, the NC device 1 advances the procedure to step S2.

(Step S2)

In step S2, on the basis of the information input as the conditions set in step S1, the NC device 1 determines the number of layering conditions, the beam intensity, the supply amount of the material 5 and the moving speed for each layering condition, and the movement path. The path generating unit 21 outputs the thus determined individual pieces of data to the command value generating unit 22. The path generating unit 21 may specify the content of a movement command with coordinate values and a G-code. The path generating unit 21 may specify the content of a speed command with an F-code. In a machining program, the content of the movement command is specified by coordinate values and a G-code indicating a movement mode. G-codes are codes each expressed by a combination of the character “G” and a number. In the machining program, the content of the speed command is specified by an F-code. F-codes are codes each expressed by a combination of the character “F” and a number representing a speed value. After performing step S2, the NC device 1 advances the procedure to step S3.

(Step S3)

In step S3, the NC device 1 generates the position command, the output command, and the supply command on the basis of the data input from the path generating unit 21. The command value generating unit 22 generates the position command in accordance with the data indicating the movement path and the determined moving speed. The command value generating unit 22 outputs the generated position command to the head drive unit 12. The command value generating unit 22 generates the output command matching the determined beam intensity. The command value generating unit 22 outputs the generated output command to the laser oscillator 2. The command value generating unit 22 generates the supply command matching the determined supply amount. The command value generating unit 22 outputs the generated supply command to the material supplying device 4.

When the additive manufacturing apparatus 100 is controlled by each of the position command, the output command, and the supply command, the workpiece 16 is locally melted into a molten pool at a position matching the position command. The material 5 in a supply amount matching the supply command is supplied to the molten pool. With the molten material welded to the position where the molten pool is formed, the molten material and the molten pool are solidified to thereby form a layer the workpiece 16. After performing step S3, the NC device 1 advances the procedure to step S4.

(Step S4)

In step S4, the NC device 1 obtains feature quantity data. Image data, which represents an object being built in accordance with a layering condition, is input to the feature quantity extracting unit 23. Such image data is input to the feature quantity extracting unit 23 on a per layering-condition basis. The feature quantity extracting unit 23 obtains the feature quantity data by extracting a feature quantity from the image data. In the first embodiment, the feature quantity includes the size of the molten pool and a distance from the center of the molten pool to the tip of the material 5, the tip of the material 5 being located on a side of the workpiece 16. The feature quantity extracting unit 23 may extract the shape of the molten pool or the state of the tip of the material 5 as the feature quantity. In this case, the feature quantity extracting unit 23 obtains feature quantity data indicating the shape of the molten pool or feature quantity data indicating the state of the tip of the material 5. After performing step S4, the NC device 1 advances the procedure to step S5.

(Step S5)

In step S5, the NC device 1 obtains shape data, that is, data on a layering height and data on a layering width. Every time the formation of a layer matching a layering condition is completed, the feature quantity extracting unit 23 extracts the data on the layering height and the data on the layering width, that is, extracts the shape data representing the shape of the layer from the image data. After performing step S5, the NC device 1 advances the procedure to step S6.

(Step S6)

In step S6, the NC device 1 estimates the welding state of the molten pool on the basis of the feature quantity data. The process map creating unit 24 estimates the welding state on the basis of a relational expression between the size of the molten pool and the distance between the center of the molten pool and the tip of the material 5. The process map creating unit 24 may estimate the welding state on the basis of the shape of the molten pool or the state of the tip of the material 5. After performing step S6, the NC device 1 advances the procedure to step S7.

(Step S7)

In step S7, the NC device 1 registers a layering condition in the process map. The process map creating unit 24 selects a layering condition that gives the “stable welding amount state”, from among a plurality of layering conditions given to the NC device 1, and registers the selected layering condition in the process map. In the process map, shape data is associated with the layering condition. After performing step S7, the procedure is advanced to step S8.

(Step S8)

In step S8, the NC device 1 determines whether or not the creation of the process map for the conditions set in step S1 has been completed. The process map creating unit 24 determines whether or not the creation of the process map through the procedures from step S3 to step S7 for each layering condition has been completed for each of the range of the beam intensity and the range of the supply amount. If the creation of the process map has not been completed (Step S8, No), the NC device 1 returns the procedure to step S3. The NC device 1 repeats the procedures from step S3 onward for a layering condition for which the registration has not been completed. If the creation of the process map has been completed (step S8, Yes), the NC device 1 terminates the operation through the procedures illustrated in FIG. 4.

The process map creating unit 24 may generate, on the basis of the created process map, a new layering condition for shape data including a layering height and a layering width that are not present in the process map. The process map creating unit 24 regenerates a process map by generating a new layering condition on the basis of the created process map. This means that the NC device 1 can regenerate, on the basis of the created process map, a process map that is easy for an operator to handle.

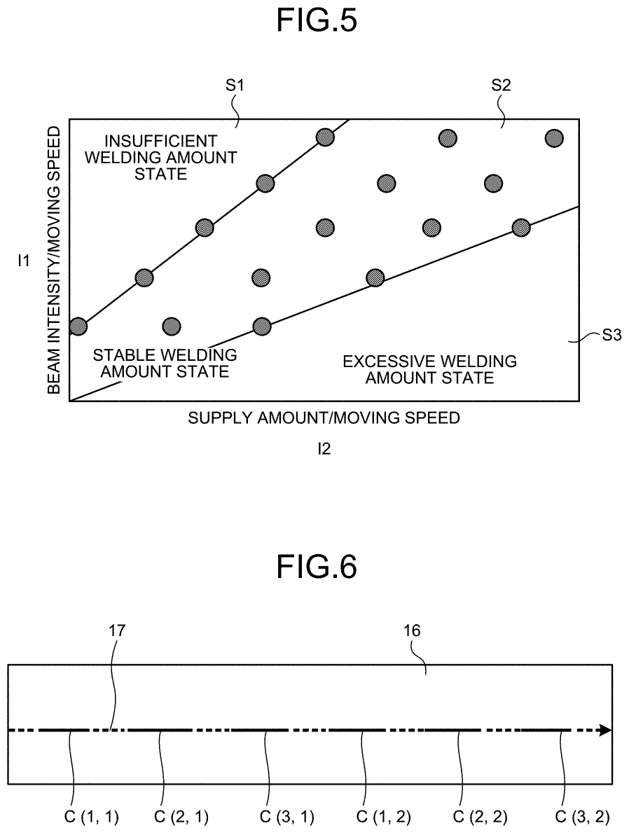

FIG. 5 is a diagram illustrating an example of a process map created by the numerical control device according to the first embodiment. In the process map illustrated in FIG. 5, the vertical axis represents I1 which is a first index value, and the horizontal axis represents I2 which is a second index value. I1 is “beam intensity/moving speed”, and I2 is “supply amount of material 5/moving speed”. Each layering condition is indicated as coordinates of a value of I1 and a value of I2 in the process map.

The supply amount of the material 5 relative to the intensity of a beam with which the workpiece 16 is irradiated becomes excessive with a decrease in a value of I1/I2, and thus, the welding state becomes the “excessive welding amount state”. On the other hand, the supply amount of the material 5 with respect to the intensity of the beam with which the workpiece 16 is irradiated becomes insufficient with an increase in the value of I1/I2, and thus, the welding state becomes the “insufficient welding amount state”. In FIG. 5, an area S1 represents the range of I1 and I2 when the welding state becomes the “insufficient welding amount state”. An area S2 represents the range of I1 and I2 when the welding state becomes the “stable welding amount state”. An area S3 represents the range of I1 and I2 when the welding state becomes the “excessive welding amount state”.

Next, the operations of each component of the NC device 1 will be explained in detail. The NC device 1 according to the first embodiment sets conditions for creating a process map for the new material 5. The set conditions include at least one of conditions such as the shape of the workpiece 16, the size of the workpiece 16, the material of the workpiece 16, the type of metal as the material 5, the diameter of the metal filament as the material 5, the range of the beam intensity, a variation width of the beam intensity, the range of the supply amount of the material 5, and a variation width of the supply amount. The variation width of the beam intensity is the width of a variation of the beam intensity when the beam intensity varies with a change to a layering condition. The variation width of the supply amount is the width of a variation of the supply amount when the supply amount varies with a change to a layering condition. Data on the set conditions is input to the path generating unit 21. The data on the set conditions may be stored in the NC device 1 in advance as parameters or the like.

(Path Generating Unit 21)

The path generating unit 21 determines a movement path and a moving speed in accordance with conditions set for creating a process map. The path generating unit 21 calculates the number of layering conditions on the basis of the following equation (1). In equation (1), “N” represents the number of layering conditions. “I” represents the number of values that can be taken by the beam intensity when the beam intensity varies with a change to a layering condition. “J” represents the number of values that can be taken by the supply amount when the supply amount varies with a change to a layering condition. “I” is expressed by the following equation (2). “J” is expressed by the following equation (3).

$$[ Formula 1 ]$$

$$N = I \times J \qquad ( 1 )$$

$$I = \frac{( {P}_{m a x} - {P}_{m i n} )}{Δ P} \qquad ( 2 )$$

$$J = \frac{( {W}_{m a x} - {W}_{m i n} )}{Δ W} \qquad ( 3 )$$

In equation (2), “Pₘₐₓ” represents a maximum beam intensity in the range of the beam intensity. “Pₘᵢₙ” represents a minimum beam intensity in the range of the beam intensity. “ΔP” represents the variation width of the beam intensity. In equation (3), “Wₘₐₓ” represents a maximum supply amount in the range of the supply amount. “Wₘᵢₙ” represents a minimum supply amount in the range of the supply amount. “ΔW” represents the variation width of the supply amount.

Assume that I=3 and J=2, and the patterns of selection of a value of the beam intensity and a value of the supply amount set six layering conditions. In this case, N=6 is obtained from calculation on the basis of the above equation (1). The six layering conditions may be hereinafter expressed as: a layering condition C(1,1); a layering condition C(2,1); a layering condition C(3,1); a layering condition C(1,2); a layering condition C(2,2); and a layering condition C(3,2). Note that the value indicating the number of layering conditions may be a value set in the NC device 1 as a parameter.

The path generating unit 21, which has calculated the number of the layering conditions, determines the beam intensity and the supply amount for each of these layering conditions. A beam intensity P(i,j) of a layering condition C(i,j) is determined by the following equation (4). A supply amount W(i,j) of the layering condition C(i,j) is determined by the following equation (5).

[Formula 2]

P(i,j)=P₀+ΔP×I (4)

W(i,j)=W₀+ΔW×J (5)

“P₀” represents an offset value for adjusting the beam intensity. “W₀” represents an offset value for adjusting the supply amount. On the basis of the shape of the workpiece 16 and the size of the workpiece 16, the path generating unit 21 determines a movement path to be used for creating the process map. When a movement path includes a curved portion, the movement path is designed so that the curvature of the curved portion decreases, in order to prevent deterioration of the layering shape due to inclusion of a greatly curved portion in the movement path. An upper limit value of the curvature is set in advance as a parameter etc., thereby allowing the path generating unit 21 to design the movement path so that the curvature becomes smaller than the upper limit value. On the basis of the shape of the workpiece 16, the path generating unit 21 may search for a movement path having a minimum one of maximum curvatures of portions of movement paths. The movement path is designed so that an interval between mutually parallel portions of the movement path is not smaller than the layering width. A lower limit value of the interval may be set in advance as a parameter etc. The path generating unit 21 may estimate a maximum value of the layering width on the basis of the range of the beam intensity or the range of the supply amount and set the estimated maximum value as the lower limit value of the interval.

Assume that the workpiece 16 has a rectangular parallelepiped shape. The path generating unit 21 determines a linear movement path having no curved portion as a movement path having a minimum curvature. The number of movement paths generated by the path generating unit 21 as the movement paths to be used for creating the process map is not limited to one, and may be more than one.

The path generating unit 21 determines the moving speed in the movement path. For the calculated number of layering conditions, the path generating unit 21 calculates the moving speed for forming a layer with the beam intensity and the supply amount of each of the layering conditions. When a layering condition is changed, the additive manufacturing apparatus 100 interrupts the formation of a layer during a period until the beam intensity reaches the beam intensity of the layering condition and the supply amount of the material 5 reaches the supply amount of the layering condition. A section of the movement path in which the formation of the layer is interrupted may be hereinafter referred to as an approach section.

The path generating unit 21 calculates the moving speed on the basis of the following equation (6). In equation (6), “F” represents the moving speed. “L” represents the length of the movement path. “N” represents the number of layering conditions. “l” represents a layering length. The layering length, which is the length of the layer in the direction of extension of the movement path, is the length of the layer formed by a single building. “Tₚ” represents a time constant of the beam intensity. The time constant of the beam intensity indicates, when a layering condition is changed, a time required for actual beam intensity to reach the beam intensity of the changed layering condition. “T_{w}” represents a time constant of the supply amount. The time constant of the supply amount indicates, when a layering condition is changed, a time constant indicating a time required for an actual supply amount of the material 5 to reach the supply amount of the changed layering condition. “Δl”, which is the length of the approach section, is set on the basis of the time constant of the beam intensity and the time constant of the supply amount. “max (T_{p,k},T_{w,k})” indicates a maximum value among the time constant of the beam intensity and the time constant of the supply amount. “k” is a variable.

$$[ Formula 3 ]$$

$$F = \frac{L - N \times l}{{\sum }_{k = 1}^{N + 1} max ( {T}_{p , k} , {T}_{w , k} )} \qquad ( 6 )$$

FIG. 6 is a diagram illustrating an example of a movement path used in creation of a process map by the numerical control device according to the first embodiment. In FIG. 6, the movement path is indicated by an arrow. The movement path illustrated in FIG. 6 includes formation sections and approach sections 17 between the formation sections. In each formation section, a layer is formed under the corresponding one of six layering conditions, i.e., the layering condition C(1,1), the layering condition C(2,1), the layering condition C(3,1), the layering condition C(1,2), the layering condition C(2,2), and the layering condition C(3,2). The path generating unit 21 outputs, to the command value generating unit 22, data determined regarding the number of layering conditions, the beam intensity, the supply amount of the material 5 and the moving speed of each layering condition, and the movement path.

(Command Value Generating Unit 22)

The command value generating unit 22 generates a position command per unit time, an output command, and a supply command on the basis of the data input from the path generating unit 21.

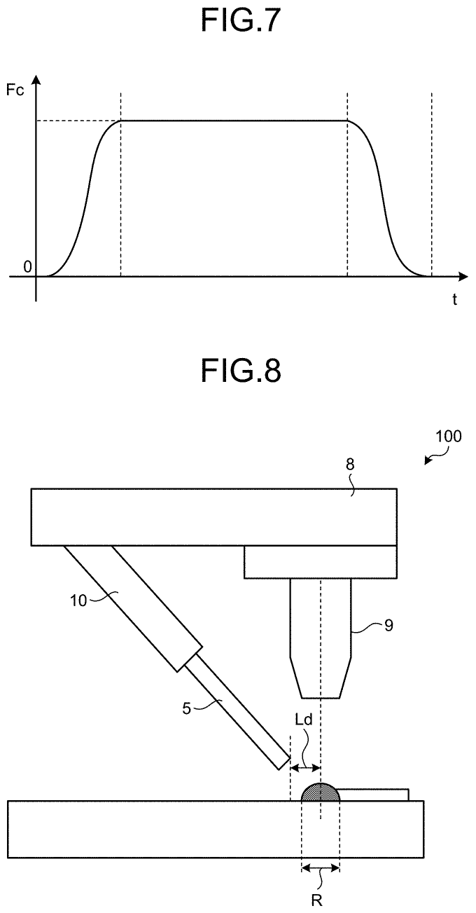

FIG. 7 is a graph illustrating an example of a speed waveform determined by the numerical control device according to the first embodiment. The speed waveform is a waveform of a graph representing a change in the moving speed. In FIG. 7, the vertical axis represents moving speed Fc, and the horizontal axis represents time t. FIG. 7 illustrates an example of a speed waveform of a speed command Fc(i,j,t) when a layer having the layering length “l” is formed under the layering condition C(i,j). The command value generating unit 22 determines the speed command Fc(i,j,t) per unit time on the basis of the layering length “l” and the determined moving speed for the layering condition (i,j). Examples of a specific process performed by the command value generating unit 22 include an acceleration/deceleration process of generating a speed waveform for acceleration/deceleration at a preset acceleration rate, and a smoothing process of smoothing the speed waveform generated by the acceleration/deceleration process. Note that the smoothing process is also called a moving average filtering process.

The command value generating unit 22 calculates interpolation points by performing an interpolation process. The interpolation point indicates a position of the machining head 8 per unit time when a supply position of the material 5 is moved in accordance with the speed command Fc(i,j,t) indicating the post-smoothing-process moving speed. The command value generating unit 22 generates the position command by the interpolation process. The command value generating unit 22 outputs the position command to the head drive unit 12, per unit time. Thus, the NC device 1 controls the movement of the machining head 8.

The command value generating unit 22 generates an output command Pc(i,j,t) at time t and a supply command Wc(i,j,t) at time t on the basis of the supply amount and the beam intensity indicated by the layering condition C(i,j,t) at time t. The command value generating unit 22 adjusts the output command Pc(i,j,t) and the supply command Wc(i,j,t), depending on the speed command Fc(i,j,t). The command value generating unit 22 outputs the output command Pc(i,j,t) to the laser oscillator 2, such that the NC device 1 controls the beam output. The command value generating unit 22 outputs the supply command Wc(i,j,t) to the material supplying device 4, such that the NC device 1 controls the supply amount of the material 5.

(Feature Quantity Extracting Unit 23)

The feature quantity extracting unit 23 obtains feature quantity data and shape data from image data indicating an object being built. The feature quantity extracting unit 23 extracts the feature quantity, the layering height, and the layering width from the image data at any timing that arrives one or more times. The time at which the feature quantity extracting unit 23 performs the extraction is not limited to the time during the building under the layering condition C(i,j). The feature quantity extracting unit 23 may perform the extraction for the layering condition C(i,j) at a timing of completion of the building under the layering condition C(i,j), or may collectively perform the extraction for each layering condition at a timing of completion of the building under the all the layering conditions.

FIG. 8 is a diagram for explaining feature quantity data obtained by the numerical control device according to the first embodiment. The feature quantity extracting unit 23 obtains feature quantity data T(i,j) by extracting a feature quantity from image data indicating a layer formed by the building matching the layering condition C(i,j). The feature quantity is a size R of the molten pool and a distance Ld between the center of the molten pool and the tip of the material 5. The size R is a diameter of the molten pool. The feature quantity extracting unit 23 obtains the feature quantity data T(i,j) by extracting the size R(i,j) and the distance Ld(i,j) and the size R(i,j) at a time of the building matching the layering condition C(i,j). The feature quantity extracting unit 23 may extract the shape of the molten pool or the state of the tip of the material 5 as the feature quantity.

The feature quantity extracting unit 23 obtains shape data K(i,j) by extracting a layering height H(i,j) and a layering width D(i,j) from the image data indicating the layer formed by the building matching the layering condition C(i,j). The shape data K(i,j) represents a cross-sectional shape of the layer. In the first embodiment, the feature quantity extracting unit 23 extracts the layering length and the layering width by approximating the cross-sectional shape to a quadrangular shape. The feature quantity extracting unit 23 may extract the layering length and the layering width by approximating the cross-sectional shape to an elliptical shape or a circular shape which are shapes other than the quadrangular shape. The feature quantity extracting unit 23 outputs the feature quantity data and the shape data to the process map creating unit 24.

(Process Map Creating Unit 24)

The process map creating unit 24 determines a welding state on the basis of the feature quantity data. In addition, the process map creating unit 24 registers, in the process map, a layering condition associated with the shape data. On the basis of a relational expression between the size R and the distance Ld as the feature quantity data, it is estimated whether the welding state corresponds to the “stable welding amount state”, the “insufficient welding amount state”, or the “excessive welding amount state”.

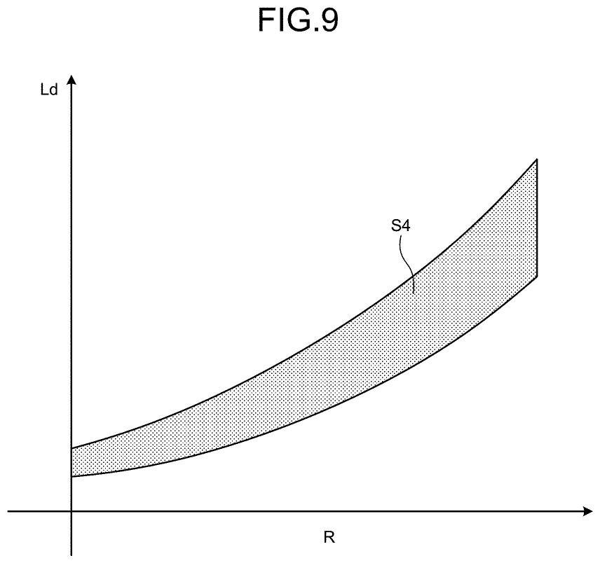

FIG. 9 is a graph for explaining a relational expression used for estimation of a molten state performed by the numerical control device according to the first embodiment. FIG. 9 illustrates a graph representing a relation between the size R of the molten pool and the distance Ld between the center of the molten pool and the tip of the material 5. In the graph, the horizontal axis represents the size R of the molten pool, and the vertical axis represents the distance Ld between the center of the molten pool and the tip of the material 5.

The supply amount of the material 5 relative to the intensity of the beam with which the workpiece 16 is irradiated becomes insufficient with an increase in the distance Ld relative to the size R of the molten pool. The welding state becomes the “insufficient welding amount state” due to the insufficient supply amount relative to the beam intensity. On the other hand, the supply amount of the material 5 relative to the intensity of the beam with which the workpiece 16 is irradiated becomes excessive with a decrease in the distance Ld relative to the size R of the molten pool. The welding state becomes the “excessive welding amount state” due to the excessive supply amount relative to the beam intensity. An area S4 represents the range of the size R and the distance Ld when the welding state becomes the “stable welding amount state”. In the NC device 1, a relational expression between the size R of the molten pool and the distance Ld is set in advance. The relational expression may be modeled in advance on the basis of the process map of an existing material held in the NC device 1. The relational expression may be stored in the NC device 1 in advance as a parameter or the like.

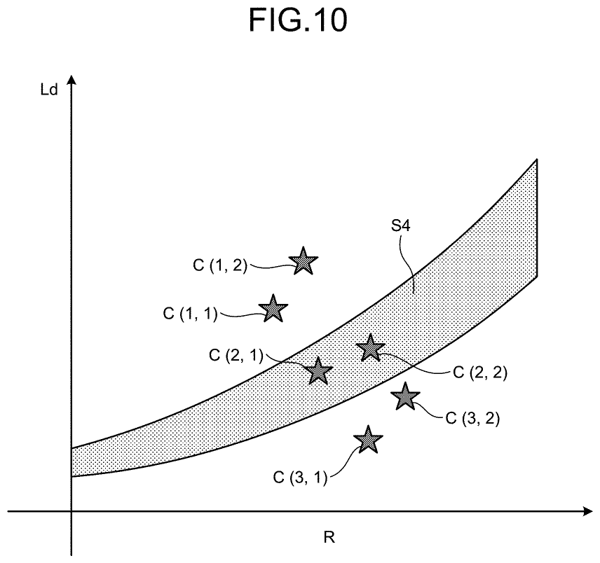

FIG. 10 is a graph illustrating an example of a result of estimation of a molten state for each layering condition performed by the numerical control device according to the first embodiment. FIG. 10 is obtained by plotting, on the graph illustrated in FIG. 9, the size R of the molten pool and the distance Ld for each of the layering condition C(1,1), the layering condition C(2,1), the layering condition C(3,1), the layering condition C(1,2), the layering condition C(2,2), and the layering condition C(3,2). The process map creating unit 24 registers, in the process map, layering conditions that give the “stable welding amount state”.

In the example illustrated in FIG. 10, the welding state becomes the “stable welding amount state” under the layering condition C(2,1) and the layering condition C(2,2). The process map creating unit 24 selects the layering condition C(2,1) and the layering condition C(2,2) on the basis of the result of determination of the welding state. The process map creating unit 24 registers an output command Pc(2,1) and a supply command Wc(2,1) and shape data K(2,1) for the layering condition C(2,1) in association with one another. The shape data K(2,1) is a layering height H(2,1) and a layering width D(2,1). The process map creating unit 24 registers an output command Pc(2,2) and a supply command Wc(2,2) and shape data K(2,2) for the layering condition C(2,2) in association with one another. The shape data K(2,2) is a layering height H(2,2) and a layering width D(2,2).

As a result, the NC device 1 creates a process map for the new material 5. Note that the NC device 1 stores the process map as a graph as illustrated in FIG. 5. Alternatively, the NC device 1 may store a database obtained by converting the data on the process map into a table.

According to the first embodiment, the NC device 1 automatically generates a path for performing building under one or more layering conditions, and the associated moving speed, and determines a welding state on the basis of feature quantity data extracted from image data representing the object 15. The NC device 1 creates a process map in which the shape of the object 15 and the layering condition for building the object are associated with each other, the layering condition being selected from among a plurality of layering conditions on the basis of the result of determination of the welding state. The NC device 1 creates a process map for supporting highly accurate building in a stable welding state, thereby improving work efficiency in adjustment for obtaining a target object.

### Second Embodiment

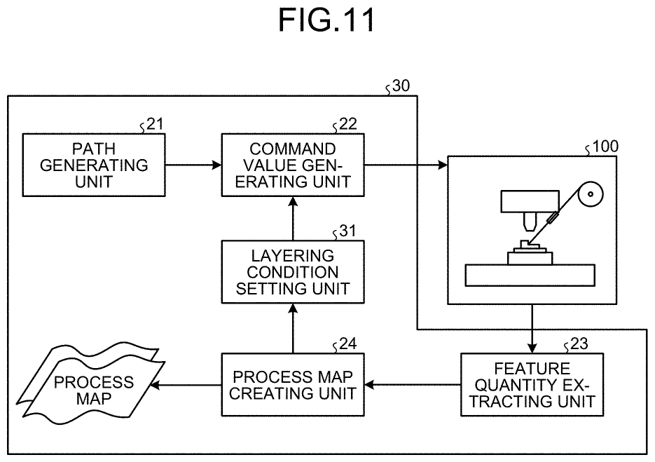

FIG. 11 is a diagram illustrating a functional configuration of a numerical control device according to a second embodiment. An NC device 30, which is the numerical control device according to the second embodiment, includes a layering condition setting unit 31 in addition to structural requirements of the NC device 1 illustrated in FIG. 2. In the second embodiment, the same components as those in the first embodiment are denoted by the same reference numerals, and configurations different from those in the first embodiment will mainly be described. The layering condition setting unit 31 adjusts at least one of the output command for the beam and the supply command of the material 5 matching a layering condition given to the NC device 30, thereby changing the content of the given layering condition.

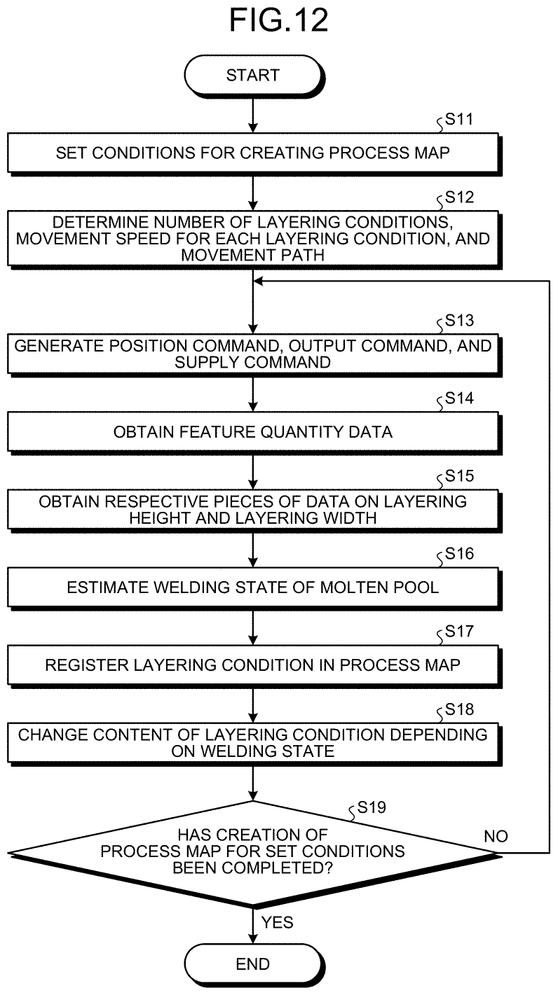

Next, the operation of the NC device 30 will be explained. FIG. 12 is a flowchart illustrating procedures of operation performed by the numerical control device according to the second embodiment.

(Step S11)

In step S11, the NC device 30 sets conditions for creating a process map similarly to step S1 illustrated in FIG. 4.

(Step S12)

In step S12, on the basis of information input as the setting conditions in step S11, the NC device 30 determines the number of layering conditions, a moving speed for each layering condition, and a movement path. The path generating unit 21 outputs the thus determined data to the command value generating unit 22. The path generating unit 21 may specify the content of a movement command by coordinate values and a G-code similarly to step S2 illustrated in FIG. 4. The path generating unit 21 may specify the content of a speed command by an F-code similarly to step S2 illustrated in FIG. 4.

(Steps S13 to S17)

In step S13, the NC device 30 generates a position command, an output command, and a supply command similarly to step S3 illustrated in FIG. 4. In step S14, the NC device 30 obtains feature quantity data similarly to step S4 illustrated in FIG. 4. In step S15, the NC device 30 obtains data on the layering height and data on the layering width similarly to step S5 illustrated in FIG. 4. In step S16, the NC device 30 estimates a welding state of the molten pool similarly to step S6 illustrated in FIG. 4. In step S17, the NC device 30 registers a layering condition in the process map similarly to step S7 illustrated in FIG. 4.

(Step S18)

In step S18, the NC device 30 changes the content of the layering condition, depending on the welding state. Regarding a layering condition under which the welding state becomes the “insufficient welding amount state”, the layering condition setting unit 31 adjusts at least one of the output command and the supply command so that the welding state becomes the “stable welding amount state”. Regarding a layering condition under which the welding state becomes the “stable welding amount state”, the layering condition setting unit 31 adjusts at least one of the output command and the supply command so that the “stable welding amount state” is maintained. The layering condition setting unit 31 changes the content of the layering condition by adjusting at least one of the output command and the supply command.

(Step S19)

In step S19, the NC device 30 determines whether or not the creation of the process map for the conditions set in step S11 has been completed. The process map creating unit 24 determines whether or not the creation of the process map through the procedures from step S13 to step S18 for each layering condition has been completed for each of the range of the beam intensity and the range of the supply amount. If the creation of the process map has not been completed (Step S19, No), the NC device 30 returns the procedure to step S13. The NC device 30 repeats the procedures from step S13 onward for a layering condition for which the registration has not been completed. If the creation of the process map has been completed (step S19, Yes), the NC device 30 terminates the operation through the procedures illustrated in FIG. 12.

The process map creating unit 24 may generate, on the basis of the created process map, a new layering condition for shape data including a layering height and a layering width that are not registered in the process map. The process map creating unit 24 regenerates a process map by generating a new layering condition on the basis of the created process map. This means that the NC device 30 can regenerate, on the basis of the created process map, the process map that is easy for an operator to handle.

Next, the operations of the respective components of the NC device 30 will be explained in detail. The NC device 30 according to the second embodiment sets conditions for creating a process map for the new material 5. The set conditions include at least one of conditions such as the shape of the workpiece 16, the size of the workpiece 16, the material of the workpiece 16, the type of metal as the material 5, the diameter of the metal filament as the material 5, the range of the beam intensity, a variation width of the beam intensity, the range of the supply amount of the material 5, and a variation width of the supply amount. Data on the set conditions is input to the path generating unit 21. The data on the set conditions may be stored in the NC device 30 in advance as parameters or the like. Assume that the patterns of selection of a value of the beam intensity and a value of the supply amount set five layering conditions. In this case, N=5 is obtained from calculation on the basis of the above equation (1).

(Layering Condition Setting Unit 31)

The layering condition setting unit 31 adjusts at least one of the output command and the supply command on the basis of the result of determination of the welding state by the process map creating unit 24. Regarding a layering condition under which the welding state is the “insufficient welding amount state”, the layering condition setting unit 31 adjusts at least one of the output command and the supply command so that the welding state becomes the “stable welding amount state”. The layering condition setting unit 31 changes the content of the layering condition on the basis of the content of two or more layering conditions used for creating the process map. In addition, regarding a layering condition under which the welding state is the “stable welding amount state”, the layering condition setting unit 31 adjusts at least one of the output command and the supply command so that the “stable welding amount state” is maintained. The layering condition setting unit 31 changes the content of the layering condition on the basis of the content of two or more layering conditions used for creating the process map.

The layering condition setting unit 31 obtains a result of determination of the welding state for the layering condition C(1,1) from the process map creating unit 24, and determines a command value of the beam output and a command value of the supply amount for the layering condition C(2,1). The welding state for the layering condition C(1,1) is the “insufficient welding amount state”. The layering condition setting unit 31 determines a command value of the beam output and a command value of the supply amount for the current layering condition on the basis of the layering conditions for the past building. Since no layering condition for the past building exists for the layering condition C(1,1), the command value of the supply amount is determined on the basis of the above equation (5). A variation width, which is “ΔW” in equation (5), is a preset parameter.

The layering condition setting unit 31 obtains, from the process map creating unit 24, a result of determination of the welding state for the layering condition C(2,1), and determines a command value of the beam output and a command value of the supply amount for the layering condition C(3,1). The layering condition C(2,1) and the layering condition C(3,1) are herein a first layering condition and a second layering condition, respectively. The first layering condition is one of a plurality of layering conditions. The second layering condition is a layering condition given for the building after the building under the first layering condition. Assume that the welding state for the layering condition C(2,1) is the “insufficient welding amount state”.

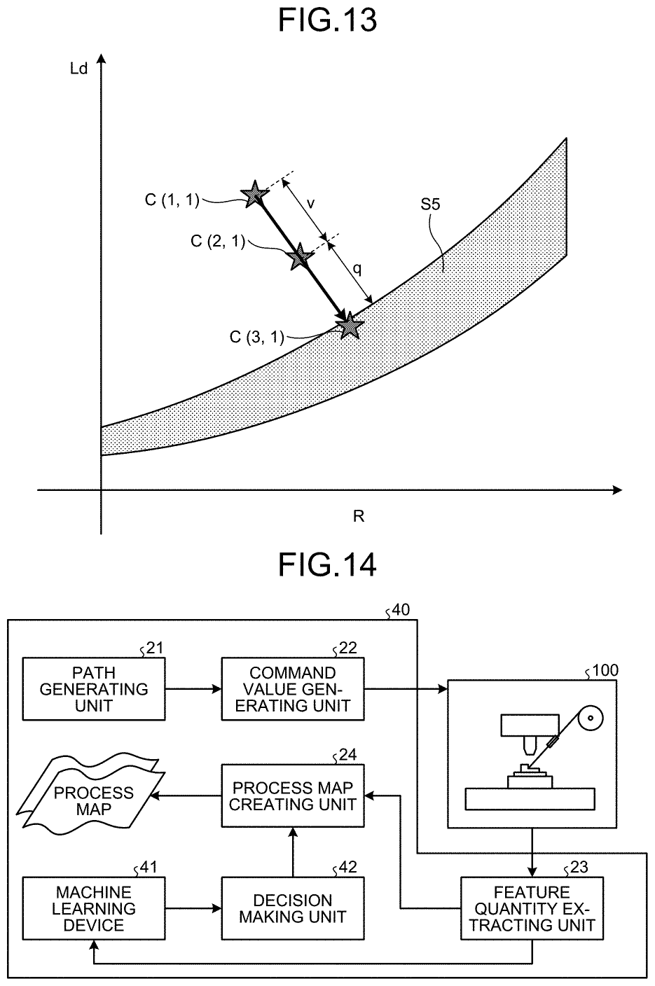

FIG. 13 is a graph for explaining a change in the content of a layering condition performed by the numerical control device according to the second embodiment. FIG. 13 illustrates a graph representing a relation between the size R of the molten pool and the distance Ld between the center of the molten pool and the tip of the material 5. In the graph, the horizontal axis represents the size R of the molten pool, and the vertical axis represents the distance Ld between the center of the molten pool and the tip of the material 5. An area S5 represents the range of the size R and the distance Ld when the welding state becomes the “stable welding amount state”.

The layering condition setting unit 31 changes a supply command Wc(i,j) under the current layering condition C(i,j) in accordance with a variation width ΔWc(i,j) calculated on the basis of the following equation (7). In equation (7), “W” represents a command value of the supply amount for a layering condition for which the welding state has already been determined by the process map creating unit 24. “v” represents a distance between plots representing two layering conditions in the graph illustrated in FIG. 13. “q” represents a distance from a plot representing one layering condition to the area S5 in the graph illustrated in FIG. 13.

$$[ Formula 4 ]$$

$$Δ Wc ( i , j ) = \frac{W - Wc ( i , j )}{v} \times q \qquad ( 7 )$$

Since the welding state for the layering condition C(2,1) is the “insufficient welding amount state”, the layering condition setting unit 31 changes a supply command Wc(3,1) for the layering condition C(3,1) in accordance with the above equation (7). At this time, “v” is a distance between a plot representing the layering condition C(1,1) and a plot representing the layering condition C(2,1). “q” is a distance from a plot representing the layering condition C(2,1) to the area S5.

Assume that a relation of ΔWc(3,1)>ΔW holds true between a variation width ΔWc(3,1) and “ΔW” which is a preset parameter. The layering condition setting unit 31 adjusts the supply command Wc(3,1) on the basis of the variation width ΔWc(3,1) as the layering condition setting unit 31 determines that even if the supply amount changes by “ΔW” from that for the layering condition C(2,1), the “insufficient welding amount state” is maintained. As a result, the layering condition setting unit 31 changes the content of the layering condition C(3,1) so that the welding state for the layering condition C(3,1) becomes the “stable welding amount state” as illustrated in FIG. 13. As described above, when the welding state at a time of building under the first layering condition is determined to be the “insufficient welding amount state”, the layering condition setting unit 31 changes the second layering condition so that the welding state for the second layering condition becomes the “stable welding amount state”.

The layering condition setting unit 31 obtains, from the process map creating unit 24, a result of determination of the welding state for the layering condition C(3,1), and determines a command value of the beam output and a command value of the supply amount for the layering condition C(4,1). The layering condition C(3,1) and the layering condition C(4,1) are herein a first layering condition and a second layering condition, respectively. The first layering condition is one of a plurality of layering conditions. The second layering condition is a layering condition given for the building after the building under the first layering condition. The welding state for the layering condition C(3,1) is adjusted by the layering condition setting unit 31 into the “stable welding amount state”.

Assume that a relation of ΔWc(4,1)>ΔW holds true between a variation width ΔWc(4,1) and “ΔW”. The layering condition setting unit 31 adjusts a supply command Wc(4,1) on the basis of the variation width ΔWc(4,1) as the layering condition setting unit 31 determines that a change in the supply amount by “ΔW” from that for the layering condition C(3,1) brings the welding state into the “excessive welding amount state” without maintaining the “stable welding amount state”. As a result, the layering condition setting unit 31 changes the content of the layering condition C(4,1) so that the “stable welding amount state” for the layering condition C(4,1) is maintained. As described above, when the welding state at a time of building under the first layering condition is determined to be the “stable welding amount state”, the layering condition setting unit 31 changes the second layering condition so that the “stable welding amount state” for the second layering condition is maintained.

The layering condition setting unit 31 obtains, from the process map creating unit 24, a result of determination of the welding state for the layering condition C(4,1), and determines a command value of the beam output and a command value of the supply amount for the layering condition C(5,1). When determining that the change in the supply amount from the supply command Wc(4,1) brings the welding state into the “excessive welding amount state”, the layering condition setting unit 31 stops the formation of a layer under the layering condition C(5,1).

The layering condition setting unit 31 adjusts the output command as in the supply command. As described above, the layering condition setting unit 31 changes the content of the layering condition by adjusting at least one of the supply command and the output command. As a result, the NC device 30 can efficiently register the layering condition in the process map.

(Process Map Creating Unit 24)

In the example described above, the welding state becomes the “stable welding amount state” under the layering condition C(3,1) and the layering condition C(4,1). The process map creating unit 24 selects the layering condition C(3,1) and the layering condition C(4,1) on the basis of the results of determination of the welding state. The process map creating unit 24 registers an output command Pc(3,1) and the supply command Wc(3,1) and shape data K(3,1) for the layering condition C(3,1) in association with one another. The shape data K(3,1) is a layering height H(3,1) and a layering width D(3,1). The process map creating unit 24 registers an output command Pc(4,1) and the supply command Wc(4,1) and shape data K(4,1) for the layering condition C(4,1) in association with one another. The shape data K(4,1) is a layering height H(4,1) and a layering width D(4,1).

As a result, the NC device 30 creates a process map for the new material 5. Note that the NC device 30 stores the process map as a graph as illustrated in FIG. 5. Alternatively, the NC device 30 may store a database obtained by converting the data on the process map into a table.

According to the second embodiment, the NC device 30 adjusts at least one of the output command and the supply command on the basis of the result of determination of the welding state by the process map creating unit 24. As a result, the NC device 30 can efficiently register the layering condition in the process map, which makes it possible to improve work efficiency in adjustment for obtaining a target modeled object.

### Third Embodiment

FIG. 14 is a diagram illustrating a functional configuration of a numerical control device according to a third embodiment. An NC device 40 according to the third embodiment learns a relation between the size R of the molten pool and the distance Ld in a case where the welding state becomes the “stable welding amount state”. The distance Ld is a distance between the center of the molten pool and the tip of the material 5 as illustrated in FIG. 8. The NC device 40 has a functional configuration for machine learning in addition to structural requirements of the NC device 1 according to the first embodiment. In the third embodiment, the same components as those in the first or second embodiment are denoted by the same reference numerals, and configurations different from those in the first or second embodiment will mainly be described.

The NC device 40 includes a machine learning device 41 and a decision making unit 42. The machine learning device 41 learns the relation between the size R of the molten pool and the distance Ld in the case where the welding state becomes the “stable welding amount state”. The decision making unit 42 determines the relation between the size R of the molten pool and the distance Ld on the basis of a result of learning by the machine learning device 41. The third embodiment will be described giving an example in which the relation between the size R of the molten pool and the distance Ld is determined by supervised learning.

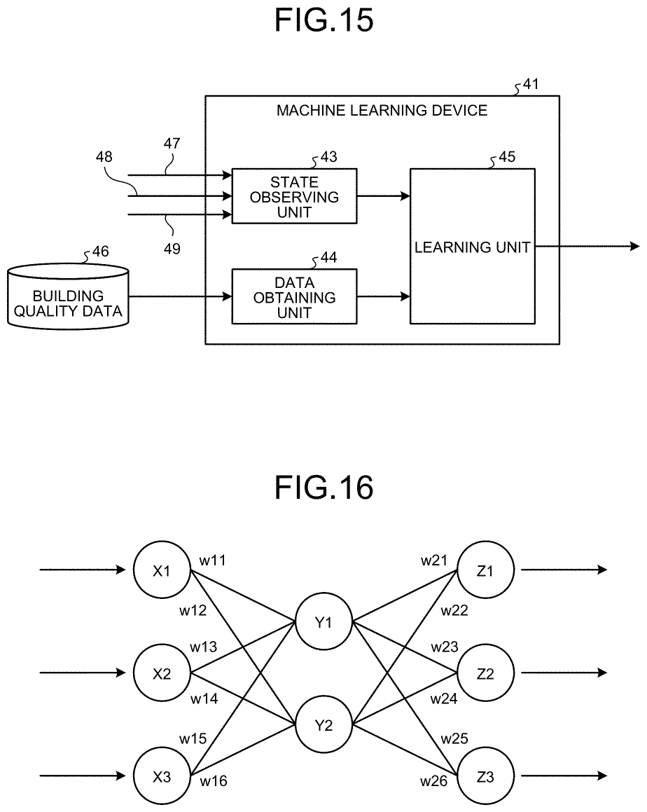

FIG. 15 is a block diagram illustrating a functional configuration of the machine learning device of the numerical control device according to the third embodiment. The NC device 40 receives an input of building quality data 46. The building quality data 46 is data representing the building quality of the object 15, and is input to the NC device 40 by an operator who has evaluated the building quality. The building quality data 46 may be input to the NC device 40 by a quality evaluation device that evaluates the building quality of the object 15 on the basis of a result of measurement of the shape of the object 15. The quality evaluation device may be a device outside the NC device 40 or may be provided inside the NC device 40. In the third embodiment, illustration of the quality evaluation device is omitted.

The machine learning device 41 includes a state observing unit 43, a data obtaining unit 44, and a learning unit 45. Size data 47 indicating the size of the molten pool and distance data 48 indicating the distance Ld are input to the state observing unit 43. A determination result 49 of the welding state provided by the process map creating unit 24 is input to the state observing unit 43. The building quality data 46 is input to the data obtaining unit 44.

The state observing unit 43 observes the size data 47, the distance data 48, and the determination result 49 as state variables. The state observing unit 43 outputs the state variables to the learning unit 45. The data obtaining unit 44 obtains the building quality data 46 which is teaching data. The data obtaining unit 44 outputs the teaching data to the learning unit 45. In accordance with a data set created on the basis of the combination of the state variables and the teaching data, the learning unit 45 learns the relation between the size R of the molten pool and the distance Ld in the case where the welding state becomes the “stable welding amount state”.

In accordance with a neural network model, for example, the learning unit 45 learns the relation between the size R of the molten pool and the distance Ld through so-called supervised learning in the case where the welding state becomes the “stable welding amount state”. Supervised learning herein refers to a model that gives a large amount of data sets to the learning unit 45 to cause the learning unit 45 to learn the features of the data sets, and estimate a result from an input. A data set includes an input and a label that is a result associated with the input. The neural network is made up of an input layer, a hidden layer, and an output layer. The input layer is defined by a plurality of neurons. The hidden layer is an intermediate layer defined by a plurality of neurons. The output layer is defined by a plurality of neurons. The number of intermediate layers may be one, or two or more.

FIG. 16 is a diagram illustrating an example of a configuration of a neural network used for learning in the fourth embodiment. The neural network illustrated in FIG. 16 is a neural network of three layers. An input layer includes neurons X1, X2, and X3. An intermediate layer includes neurons Y1 and Y2. An output layer includes neurons Z1, Z2, and Z3. Note that the number of neurons in each layer may be any number. A plurality of values input to the input layer are multiplied by w11, w12, w13, w14, w15, and w16 that are weights W1, and input to the intermediate layer. A plurality of values input to the intermediate layer are multiplied by w21, w22, w23, w24, w25, and w26 that are weights W2, and output from the output layer. Output results output from the output layer vary depending on the values of the weights W1 and W2.

The learning unit 45 creates data sets on the basis of a combination of: the size R and the distance Ld observed by the state observing unit 43; and the building quality data 46 obtained by the data obtaining unit 44. The neural network of the learning unit 45 learns the relation between the size R of the molten pool and the distance Ld in the case where the welding state becomes the “stable welding amount state” through so-called supervised learning in accordance with the created data sets. That is, the neural network learns the relation between the size R of the molten pool and the distance Ld in the case where the welding state becomes the “stable welding amount state” by adjusting the weights W1 and W2 so that results output from the output layer in response to input of a value of the size R and a value of the distance Ld to the input layer are approximated to the teaching data which is the building quality data 46.

The neural network can also learn, through so-called unsupervised learning, a relation between a relative distance between the center of the molten pool and the tip of the metal filament and the size of the molten pool that brings the welding state into the “stable welding amount state”. Unsupervised learning refers to a model that gives a large amount of input data to the learning unit 45 without giving teaching data thereto to cause the learning unit 45 to learn how the input data is distributed.

One technique of unsupervised learning is clustering that groups input data on the basis of the similarity of input data. Using the result of clustering, the learning unit 45 assigns the outputs so that a certain criterion becomes optimum, thereby generating a predictive model of the outputs. The learning unit 45 may learn the presence and absence of an anomaly or measurement results by semi-supervised learning. The semi-supervised learning is a model that is a combination of unsupervised learning and supervised learning. The semi-supervised learning is learning that gives some pieces of input data teaching data associated with the input data without giving teaching data to the other pieces of the input data.

In accordance with a data set created for a plurality of additive manufacturing apparatus 100, the learning unit 45 may learn the relation between the size R of the molten pool and the distance Ld in the case where the welding state becomes the “stable welding amount state”. The learning unit 45 may learn the relation between the storage temperature and the layering volume in accordance with data sets created for a plurality of additive manufacturing apparatuses 100. The learning unit 45 may obtain data sets from a plurality of additive manufacturing apparatuses 100 used at the same site, or may obtain data sets from a plurality of additive manufacturing apparatuses 100 used at sites different from each other. The data sets may be collected from a plurality of additive manufacturing apparatuses 100 operating independently of each other at a plurality of sites. A new additive manufacturing apparatus 100 from which a data set is to be collected may be added after collection of data sets from a plurality of additive manufacturing apparatuses 100 is started. In addition, some of a plurality of additive manufacturing apparatuses 100 from which data sets are to be collected may be excluded after collection of data sets from a plurality of additive manufacturing apparatuses 100 is started.

The learning unit 45 that has performed learning in one NC device 40 may be attached to a next NC device 40 other than the one NC device 40. The learning unit 45 attached to the next NC device 40 can update the predictive model of outputs through relearning in the next NC device 40.

Deep learning that learns extraction of feature quantities may be used for the learning algorithm used by the learning unit 45. The learning unit 45 may perform machine learning in accordance with a known method other than deep learning, such as genetic programming, functional logic programming, and a support vector machine.

The machine learning device 41 is not limited to that included in the NC device 40. The machine learning device 41 may be a device external to the NC device 40. The machine learning device 41 may be a device that can be connected with the NC device 40 via a network. The machine learning device 41 may be a device present in a cloud server.

According to the third embodiment, the NC device 40 learns the relation between the size R of the molten pool and the distance Ld in the case where the welding state becomes the “stable welding amount state”. The process map creating unit 24 can accurately calculate, on the basis of the relation determined by the learning, the size R of the molten pool and the distance Ld in the case where the welding state becomes the “stable welding amount state”. As a result, the NC device 40 can accurately register the layering condition under which the welding state becomes the “stable welding amount state”. Note that machine learning similar to that in the third embodiment may be applied to the NC device 30 according to the second embodiment.

Next, a hardware configuration of the NC devices 1, 30, and 40 according to the first to third embodiments will be described. The functions of the NC devices 1, 30, and 40 are implemented with the use of processing circuitry. The processing circuitry is dedicated hardware mounted on each of the NC devices 1, 30, and 40. The processing circuitry may be a processor that executes a program stored in a memory.

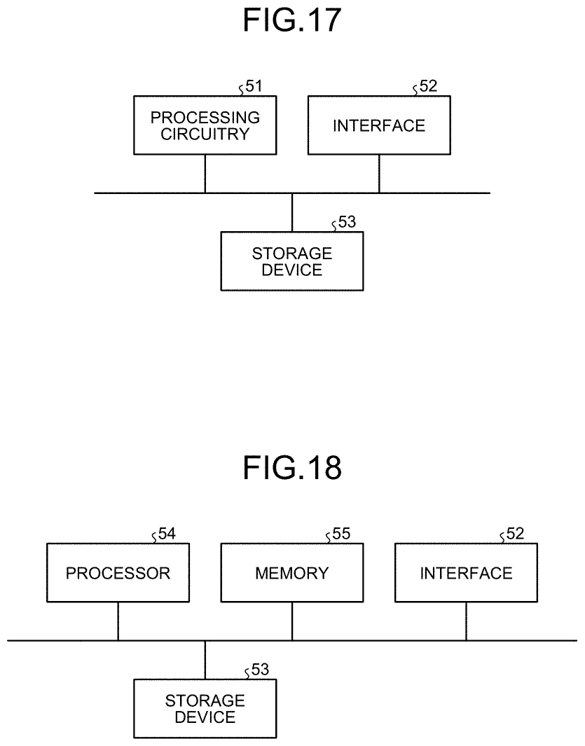

FIG. 17 is a first diagram illustrating an example of a hardware configuration of the numerical control devices according to the first to third embodiments. FIG. 17 illustrates a hardware configuration in a case where the functions of the NC devices 1, 30, and 40 are implemented with the use of dedicated hardware. The NC devices 1, 30, and 40 each include a processing circuitry 51 that executes various processes, an interface 52 for connection with a device outside the NC devices 1, 30, and 40 or input and output of information, and a storage device 53 that stores information.

The processing circuitry 51 as dedicated hardware is a single circuit, a composite circuit, a programmed processor, a parallel programmed processor, an application specific integrated circuit (ASIC), a field-programmable gate array (FPGA), or a combination thereof. The functions of the path generating unit 21, the command value generating unit 22, the feature quantity extracting unit 23, the process map creating unit 24, the layering condition setting unit 31, the machine learning device 41, and the decision making unit 42 are implemented with the use of the processing circuitry 51. The process map is stored in the storage device 53. Each command generated by the command value generating unit 22 is output from the interface 52 to each component.

FIG. 18 is a second diagram illustrating an example of a hardware configuration of the numerical control devices according to the first to third embodiments. FIG. 18 illustrates a hardware configuration in a case where the functions of the NC devices 1, 30, and 40 are implemented with the use of hardware that executes a program.

A processor 54 is a central processing unit (CPU), a processing device, an arithmetic device, a microprocessor, a microcomputer, or a digital signal processor (DSP). The functions of the path generating unit 21, the command value generating unit 22, the feature quantity extracting unit 23, the process map creating unit 24, the layering condition setting unit 31, the machine learning device 41, and the decision making unit 42 are implemented by the processor 54 and software, firmware, or a combination of software and firmware. The software or the firmware is described as a program and stored in a memory 55 as a built-in memory. The memory 55 is a nonvolatile or volatile semiconductor memory, and is a random access memory (RAM), a read only memory (ROM), a flash memory, an erasable programmable read only memory (EPROM), or an electrically erasable programmable read only memory (EEPROM (registered trademark)).

The configurations described in the embodiments above are merely examples of the content of the present disclosure. The configurations of the respective embodiments can be combined with other known technology. The configurations of the respective embodiments may be appropriately combined. Part of the configurations of the respective embodiments can be omitted or modified without departing from the gist of the present disclosure.

### REFERENCE SIGNS LIST

1, 30, 40 NC device; 2 laser oscillator; 3 fiber cable; 4 material supplying device; 5 material; 6 gas supplying device; 7 piping; 8 machining head; 9 beam nozzle; 10 material nozzle; 11 gas nozzle; 12 head drive unit; 13 stage; 14 base material; 15 modeled object; 16 workpiece; 17 approach section; 21 path generating unit; 22 command value generating unit; 23 feature quantity extracting unit; 24 process map creating unit; 31 layering condition setting unit; 41 machine learning device; 42 decision making unit; 43 state observing unit; 44 data obtaining unit; 45 learning unit; 46 modeling quality data; 47 size data; 48 distance data; 49 determination result; 51 processing circuitry; 52 interface; 53 storage device; 54 processor; 55 memory; 100 additive manufacturing apparatus.

1. A numerical control device to control an additive manufacturing apparatus for producing an object by layering a material on a workpiece, the material being melted by being irradiated with a beam, the numerical control device comprising:
feature quantity extracting circuitry to extract, from image data, a feature quantity for determining a welding state that is a state where a molten material is added to the workpiece; and
process map creating circuitry to create a process map in which a shape of the object and a layering condition are associated with each other, the layering condition being selected from among a plurality of layering conditions on a basis of a result of determination of the welding state and including at least one of beam intensity and a supply amount of a material.

2. The numerical control device according to claim 1, wherein the feature quantity is a distance from a center of a molten pool to a tip of a material, the molten pool being formed on the workpiece by melting of a material, the tip of the material being located on a side of the workpiece.

3. The numerical control device according to claim 2, wherein
the feature quantity extracting circuitry extracts, from the image data, shape data representing a shape of a layer formed in accordance with a layering condition given to the numerical control device, and
the process map creating unit creates the process map in which the shape data is associated with a layering condition.

4. The numerical control device according to claim 1, comprising layering condition setting circuitry to change a content of a layering condition given to the numerical control device, by adjusting at least one of an output command for the beam and a supply command of the material that match the given layering condition.

5. The numerical control device according to claim 4, wherein when a welding state at a time of building under a first layering condition is determined to be a first welding state, the layering condition setting circuitry changes a second layering condition so that a welding state for the second layering condition becomes a second welding state, the first layering condition being one of the plurality of layering conditions, the first welding state being a state where addition of a molten material to the workpiece is insufficient, the second layering condition being the given layering condition for building after the building under the first layering condition, the second welding state being a state where a layer having a target shape is capable of being formed.

6. The numerical control device according to claim 4, wherein when a welding state at a time of building under a first layering condition is determined to be a second welding state, the layering condition setting circuitry changes a second layering condition so that the second welding state is maintained, the first layering condition being one of the plurality of layering conditions, the second welding state being a state where a layer having a target shape is capable of being formed, the second layering condition being the given layering condition for building after the building under the first layering condition.

7. The numerical control device according to claim 1, comprising path generating circuitry to generate, in accordance with a condition set for creating the process map, a movement path that is a path for moving a supply position of a material.

8. The numerical control device according to claim 7, wherein the path generating circuitry generates the movement path including a section in which formation of a layer is interrupted when a layering condition is changed.

9. The numerical control device according to claim 1, wherein the process map creating circuitry generates, on a basis of the created process map, a new layering condition for shape data not registered in the process map.

10. The numerical control device according to claim 1, comprising:
machine learning circuitry to learn a relation between a size of a molten pool and a distance from a center of the molten pool to a tip of a material, the molten pool being formed on the workpiece by melting of a material, the tip of the material being located on a side of the workpiece, the relation being obtained when a welding state is a welding state where a layer having a target shape is capable of being formed; and
decision making circuitry to decide the relation on a basis of a result of learning by the machine learning circuitry, wherein
the machine learning device includes:
state observing circuitry to observe the size and the distance as state variables; and
learning circuitry to learn the relation in accordance with a data set created on a basis of the state variables.

11. A method for controlling an additive manufacturing apparatus by using a numerical control device, the additive manufacturing apparatus producing an object by layering a material on a workpiece, the material being melted by being irradiated with a beam, the method comprising:
extracting, from image data, a feature quantity for determining a welding state that is a state where a molten material is added to the workpiece; and
creating a process map in which a shape of the object and a layering condition are associated with each other, the layering condition being selected from among a plurality of layering conditions on a basis of a result of determination of the welding state and including at least one of beam intensity and a supply amount of a material.

12. The numerical control device according to claim 2, wherein the feature quantity includes a size of a molten pool.

13. The numerical control device according to claim 3, wherein the process map creating unit creates the process map, selecting, from among the plurality of layering conditions, a layering condition that gives a stable welding state without selecting, from among the plurality of layering conditions, a layering condition that gives a welding state other than the stable welding state, the stable welding state being a welding state where a layer having a target shape is capable of being formed.
